(19) United States
(12) Patent Application Publication
(10) Pub. No.: US 2008/0097954 A1
(43) Pub. Date: Apr. 24, 2008

(54) Ranged lookups

(75) Inventors: Tanmoy Dutta, Redmond, WA (US); Raul Garcia, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/584,779

(22) Filed: Oct. 20, 2006

(51) Int. Cl. G06F 17/30

(52) U.S. Cl. 707/1

(57) ABSTRACT

A requester may request a ranged lookup operation with respect to an encrypted column of a database. An indexing structure may be used to perform the ranged lookup operation. The indexing structure may include multiple entries. Each of the entries of the indexing structure may include an index value and retrieval information for retrieving a corresponding row of the database. The index value of each entry may correspond to a respective decrypted data item from the encrypted column of the database, which was transformed by a transformation function such that the transformed decrypted data item may reveal less information than the decrypted data item before being transformed by the transformation function. When the respective index value of one of the entries of the indexing structure satisfies the received ranged lookup request, the respective retrieval information may be used to retrieve a corresponding row of data from the database.

### BACKGROUND

Companies use database systems to store and search data used in various aspects of their businesses. The data may include as many as several million records, at least some of which the companies wish to keep private, such as, for example, customer information. Such information may be of value to others who may have a malicious intent. If a company's adversary was able to obtain such private information, the adversary could create problems for the company, its customers, or both.

One common method used to protect valuable information in a database and to comply with privacy regulations or policies is encryption. However, use of encrypted data in a database raises other issues, such as, for example, how to permit authorized access to the data by existing applications and how to find particular items of the data without decrypting all of the data and performing a linear search.

While solutions exist for performing equality based lookups on encrypted data in a database, a solution for performing ranged lookups is desired, but is not trivial.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to database systems in which a ranged lookup may be performed on encrypted data.

In one embodiment, a ranged lookup request with respect to an encrypted column of a database may be received. An indexing structure, including multiple entries, may be traversed to find one or more entries that satisfy the ranged lookup request. Each of the entries of the indexing structure may include an index value and retrieval information for retrieving a corresponding row of the database. The index value may correspond to a respective decrypted data item from the encrypted column having been transformed by a transformation function. The index value reveals less information than the corresponding decrypted data item. When the respective index value of one of the entries of the indexing structure satisfies the received ranged lookup request, the respective retrieval information may be used to retrieve the corresponding row of data from the database.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates an exemplary operating environment for embodiments consistent with the subject matter of this disclosure.

FIG. 2 illustrates a functional block diagram of an exemplary processing device which may implement processing device 102 and/or processing device 104 of FIG. 1.

FIGS. 3A and 3B illustrate an exemplary indexing structure which may be used in implementations consistent with the subject matter of this disclosure.

FIG. 4 is a flowchart of an exemplary process that may be implemented in embodiments consistent with the subject matter of this disclosure for creating an indexing structure.

FIG. 5 is a flowchart of an exemplary process that may be implemented in embodiments consistent with the subject matter of this disclosure for performing a ranged lookup request.

FIG. 6 is a flowchart of an exemplary process may be implemented in embodiments consistent with the subject matter of this disclosure for permitting a user to define or redefine a transformation function.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

### Exemplary Operating Environment

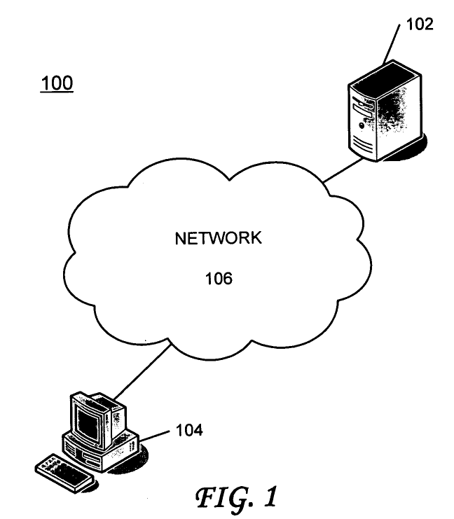

FIG. 1 illustrates an exemplary operating environment 100 for an embodiment consistent with subject matter of this disclosure. Operating environment 100 may include a processing device 102, a processing device 104 and a network 106.

Processing device 102 may be, for example, a server or other processing device capable of executing a database system. Processing device 104 may be a personal computer (PC) or other processing device capable of executing applications and communicating with processing device 102 via network 106.

Network 106 may be a wired or wireless network and may include a number of devices connected via wired or wireless means. Network 104 may include only one network or a number of different networks, some of which may be networks of different types.

In operating environment 100, processing device 104 may execute an application, which accesses information in a database of processing device 102 via network 106. The application may create, delete, read or modify data in the database of processing device 102.

FIG. 1 illustrates an exemplary operating environment. Other operating environments or variations of operating environment 100 may be used with other embodiments consistent with the subject matter of this disclosure. For example, FIG. 1 illustrates processing device 102 and processing device 104 as being separate devices. However, processing devices 102 and 104 may be combined in a single processing device in one embodiment. In such an embodiment, the operating environment may not include network 106. In another embodiment, functions or services performed by processing device 102 may be distributed across multiple processing devices which may be connected via a network, such as, for example, network 106.

### Exemplary Processing Device

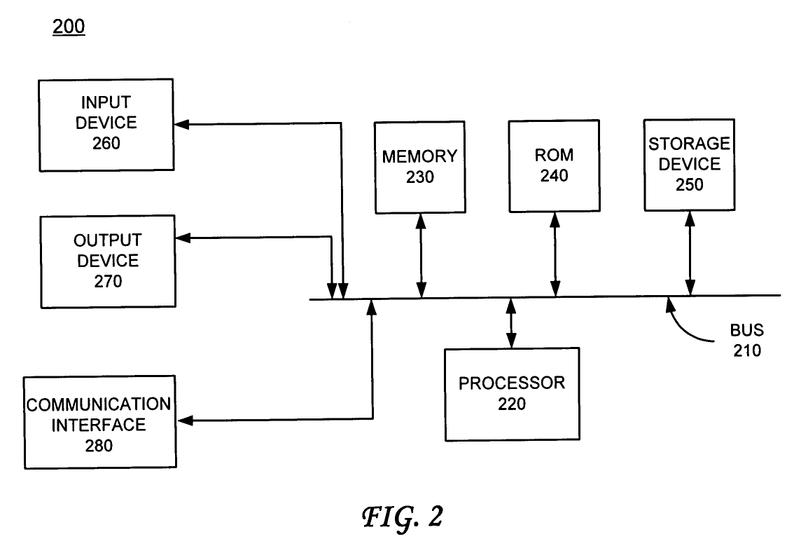

FIG. 2 is a functional block diagram which illustrates an exemplary processing device 200, which may be used to implement processing device 102, processing device 104, or both devices. Processing device 200 may include a bus 210, a processor 220, a memory 230, a read only memory (ROM) 240, a storage device 250, an input device 260, an output device 270, and a communication interface 280. Bus 210 may permit communication among components of processing device 200. In embodiments in which processing device 200 is used to implement both processing device 102 and processing device 104 in a single processing device, communication interface 280 may not be included as one of the components of processing device 200.

Processor 220 may include at least one conventional processor or microprocessor that interprets and executes instructions. Memory 230 may be a random access memory (RAM) or another type of dynamic storage device that stores information and instructions for execution by processor 220. Memory 230 may also store temporary variables or other intermediate information used during execution of instructions by processor 220. ROM 240 may include a conventional ROM device or another type of static storage device that stores static information and instructions for processor 220. Storage device 250 may include any type of media for storing data and/or instructions. When processing device 200 is used to implement processing device 102, storage device 250 may include one or more databases of a database system.

Input device 260 may include one or more conventional mechanisms that permit a user to input information to processing device 200, such as, for example, a keyboard, a mouse, or other input device. Output device 270 may include one or more conventional mechanisms that output information to the user, including a display, a printer, or other output device. Communication interface 280 may include any transceiver-like mechanism that enables processing device 200 to communicate with other devices or networks. In one embodiment, communication interface 280 may include an interface to network 106.

Processing device 200 may perform such functions in response to processor 220 executing sequences of instructions contained in a computer-readable medium, such as, for example, memory 230, or other medium. Such instructions may be read into memory 230 from another computer-readable medium, such as storage device 250, or from a separate device via communication interface 280.

### Overview

In a typical database system, data may be viewed as being stored in tables. A row of the table may correspond to a record in a file. Some database systems may permit data stored in a column of a table to be encrypted. Such database systems may permit an equality search on data in the encrypted column, provided the data is deterministically encrypted. That is, a search for rows in a table having a particular plaintext value corresponding to deterministically encrypted ciphertext in an encrypted column of the database may be performed. Deterministic encryption always encrypts plaintext items to the same corresponding ciphertext items when using a given cryptographic key. Thus, data patterns may be recognizable resulting in information leakage.

Non-deterministic encryption methods such as, for example, use of block ciphers in cipher-block chaining (CBC) mode with a random initialization vector, or other non-deterministic encryption methods, may encrypt the same plaintext data items to different ciphertext data items. For example, non-deterministic encryption according to use of block ciphers in CBC mode with a random initialization vector, may encrypt each block of plaintext by XORing a current block of plaintext with a previous ciphertext block before encrypting the current block. Thus, a value of a ciphertext data item may be based not only on a corresponding plaintext data item and a cryptographic key, but may also be based on other data, such as, for example, previously encrypted blocks of data or a random initialization vector.

Embodiments consistent with the subject matter of this disclosure relate to database systems in which ranged lookups may be performed on deterministically or non-deterministically encrypted data of an encrypted column of a database. In one embodiment, an indexing structure for performing a ranged lookup on data in an encrypted column of a database is provided. The indexing structure may include a number of entries. Each of the entries may include an index value, which may be calculated by decrypting a respective data item from the encrypted column of the database and applying a transformation function to the respective decrypted data item to produce the index value. The transformation function may be defined in such a way that the produced index value reveals less information than the corresponding decrypted data item from the encrypted column of the database.

In some implementations, the transformation function may be defined for a particular encrypted column of the database. In embodiments consistent with the subject matter of this disclosure, a user may be permitted to define or modify the transformation function for the particular encrypted column of the database. In some implementations, only those users who are authorized to modify and retrieve decrypted data from all encrypted columns of the database may be permitted to define or modify the transformation function for a particular encrypted column of the database. In such implementations, restricting which ones of the users who are permitted to define or modify the transformation function to only those users who are authorized to modify and retrieve decrypted data from all encrypted columns of the database may prevent an escalation of privileges attack.

As an example of an escalation of privileges attack, assume that a database system permits a user to define a transformation function for an encrypted column of the database even when the user is not authorized to access decrypted data for the encrypted column. The user may define or modify the transformation function to be weak such that all or nearly ail information from respective decrypted data items from the encrypted column of the database may be stored as index values of an indexing structure for performing a ranged lookup operation. At this point, a copy or equivalent, provided by the weak transformation function of the encrypted data, may be available in plaintext in the system, thereby allowing the user to look directly at it, nullifying the benefits of data encryption.

In embodiments consistent with the subject matter of this disclosure, after a user defines or modifies the transformation function for a particular encrypted column of the database, index values in respective entries of the indexing structure of the database may be recalculated according to the modified transformation function and the indexing structure may be rearranged such that a ranged lookup may be performed by traversing the indexing structure according to the recalculated index values.

In some implementations, one or more ranged lookup operators may be defined for performing ranged lookups on a particular encrypted column of the database. In such implementations, use of a ranged lookup operator, which is not defined for performing a ranged lookup on the particular encrypted column of the database, may result in a failed ranged lookup operation.

In one implementation, the indexing structure may include a B-tree or other indexing structure, which may be used to perform a ranged lookup operation to find one or more rows in the database having a particular plaintext data item, corresponding to encrypted data of an encrypted column of the database, which satisfies the ranged lookup operation.

### Exemplary Methods

Database systems typically use some type of indexing scheme for quickly searching data stored in a column of a database in order to access particular records or rows. One well-known indexing scheme includes use of a B-tree, although other indexing schemes may also be used in other embodiments.

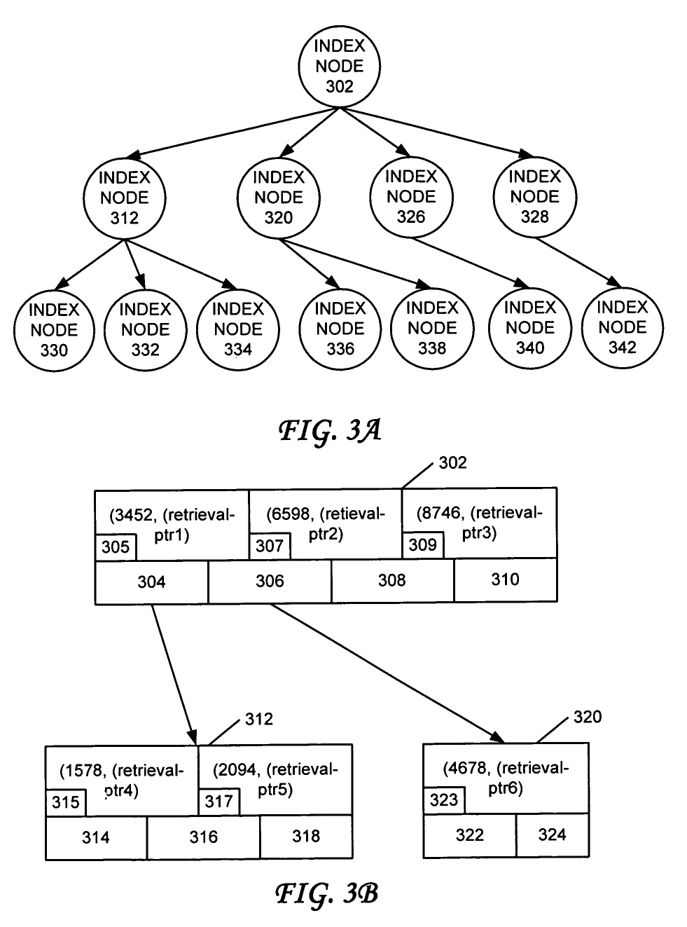

FIG. 3A illustrates an exemplary B-tree which may be used as an indexing structure for use in performing a ranged lookup operation in embodiments consistent with the subject matter of this disclosure. The exemplary B-tree may include index nodes 302, 312, 320, 326, 328, 30, 332, 334, 336, 338, 340, and 342. Each of the index nodes may include one or more entries. The index nodes, which are not leaf nodes, may include one or more links to other index nodes. For example, index node 302 may include a number of entries and may further include links to other index nodes, such as index nodes 312, 320, 326 and 328. Index node 312 may include a number of entries and may further include links to other index nodes, such as index nodes 330, 332 and 334, which in this example, may be leaf nodes. Index node 320 may include at least one entry and a link to index nodes 336 and 338, which in this example, may be leaf nodes. Index node 326 may include at least one entry and a link to index node 340, which in this example may be a leaf node. Index node 328 may include at least one entry and a link to index node 342, which in this example may be a leaf node.

FIG. 3B illustrates a more detailed view of exemplary index nodes 302, 312 and 320 of FIG. 3A consistent with the subject matter of this disclosure. In this exemplary B-tree indexing structure, each entry in the index nodes may include an index value and retrieval information such as, for example, a pointer to a corresponding row in a database. For example, index node 302 may include a first item having an index value, which may have been calculated by decrypting a data item from a particular encrypted column of a database and applying a transformation function to produce the index value, such that the index value reveals less information than the decrypted data item. As an example, the index values of the respective entries of index nodes 302, 312 and 320 may have been produced by decrypting data items of an encrypted column of the database, which may include Social Security numbers, and applying a transformation function, such as a transformation function that may produce a value equal to the last four digits of the Social Security number. Thus, the respective index values of the entries of index nodes 302, 312 and 320 may be the last four digits of corresponding Social Security numbers in the encrypted column of the database. In exemplary index node 302, a first entry of index node 302 may correspond to a Social Security number having 3452 as the last four digits, a second entry of index node 302 may correspond to a Social Security number having 6598 as the last four digits, a third entry of index node 302 may correspond to a Social Security number having 8746 as the last four digits. Retrieval-ptr1, retrieval-ptr2, and retrieval-ptr3 may include information for retrieving a row of the database corresponding to the respective entry of index node 302. As can be seen in FIG. 3B, index node 312 may include two entries. A first entry of index node 312 may include an index value, 1578, corresponding to a Social Security number having 1578 as the last four digits, and a second entry of index node 312 may include an index value, 2094, corresponding to a Social Security number having 2094 as a last four digits. Retrieval-ptr4 and retrieval-ptr5 may include information for retrieving a row of the database corresponding to the respective entries of index node 312. Index node 320 may include an index value, 4678, corresponding to a Social Security number having 4678 as the last four digits. Retrieval-ptr6 of index node 320 may include information for retrieving a corresponding row of the database.

Index node 302 may include a link 304, which may be a link to index node 312 having entries with corresponding index values less than index value 3452 of index node 302, a link 306, which is a link to index node 320 having an entry with a corresponding index value greater than index value 3452 and less than index value 6598 of index node 302, a link 308, which may link index node 302 to index node 326 having one or more entries with respective index values greater than index value 6598 and less than index value 8746 of index node 302, and a link 310, which may link index node 302 to an index node 328 having one or more entries with respective index values greater than index value 8746 of index node 302.

Further, index node 312 may include a link 314 to index node 330, which may include one or more entries having index values less than index value 1578 of index node 312, a link 316 to index node 332, which may include one or more entries including index values greater than index value 1578 and less than index value to 2094 of index node 312, and a link 318 to index node 334, which may include one or more entries including index values greater than index value 2094 of index node 312. Index node 320 may include a link 322 to index node 336, which may include one or more entries including index values less than index value 4678 of index node 320, and a link 324 to index node 338, which may include one or more entries including index values greater than index value 4678 of index node 320.

Because a ranged lookup operation may result in a number of rows of the database which satisfy the ranged lookup operation, the exemplary B-tree indexing structure of FIG. 3B may include a modification such that a number of entries with equal index values may easily be accessed. For example, entries in exemplary index nodes 302, 312 and 320 may have links to other entries with equal index values. As shown in FIG. 3B, the first entry of index node 302 may include a link 305 to link the first entry of index node 302 to another entry of the indexing structure (not shown) having an index value 3452, the second entry of index node 302 may include a link 307 to link the second entry of index node 302 to another entry of the indexing structure (not shown) having an index value 6598, and the third entry of index node 302 may include a link 309 to link the third entry of index node 302 to another entry of the indexing structure (not shown) having an index value 8746. The first entry of index node 312 may include a link 315 to link the first entry of index node 312 to another entry of the indexing structure (not shown) having an index value 1578, and the second entry of index node 312 may include a link 317 to link the second entry of index node 312 to another entry of the indexing structure (not shown) having an index value 2094. The first entry of index node 320 may include a link 323 to link the first entry of index node 320 to another entry of the indexing structure (not shown) having an index value 4678.

Each of the index nodes may include a different number of items than as shown in the exemplary indexing structure of FIG. 3B. For example, index nodes 302, 312, or 320 may have a different number of items included within the respective index nodes than as shown in FIG. 3B. Further, the transformation function described above is only an exemplary transformation function. Other transformation functions may be defined such that a value produced by applying the transformation function to a data item from an encrypted column of the database reveals less information than the data item from the encrypted column of the database. As another transformation function example, suppose data items in an encrypted column of the database include employees' annual salary. An exemplary transformation function may be defined to transform an annual salary in a range from $0-$40,000 to a value of 1, $40,001-$90,000 to a value of 2, etc. Of course, other transformation functions may also be defined such that values produced by the transformation functions when applied to data items from the encrypted column reveal less information than the data items from the encrypted column.

In embodiments consistent with the subject matter of this disclosure, an indexing structure, such as, for example, the indexing structure of FIGS. 3A and 3B, may be updated by processing device 102 by adding an item to an index node or by adding a new index node that includes a new item, such that links corresponding to the new item in the indexing structure perform in the manner illustrated in FIGS. 3A and 3B. That is, each new item added to a node in the indexing structure, which is not a leaf node, may have a link pointing to an index node including one or more items having a respective index value that is less than the index value of the added item and a second link pointing to an index node including one or more items having a respective index value that is greater than the index value of the added item. Further, when a new index node is added to the indexing structure, processing device 102 may update at least one of the existing links of the indexing structure to point to the new index node. Each new item that processing device 102 may add to the indexing structure may include a respective index value and a reference to a corresponding row of the database. Further, one or more entries of the indexing structure having an index value equal to the index value of the newly added entry may have a link to the newly added entry, or the newly added entry may have a link to at least one entry of the indexing structure having an equal index value.

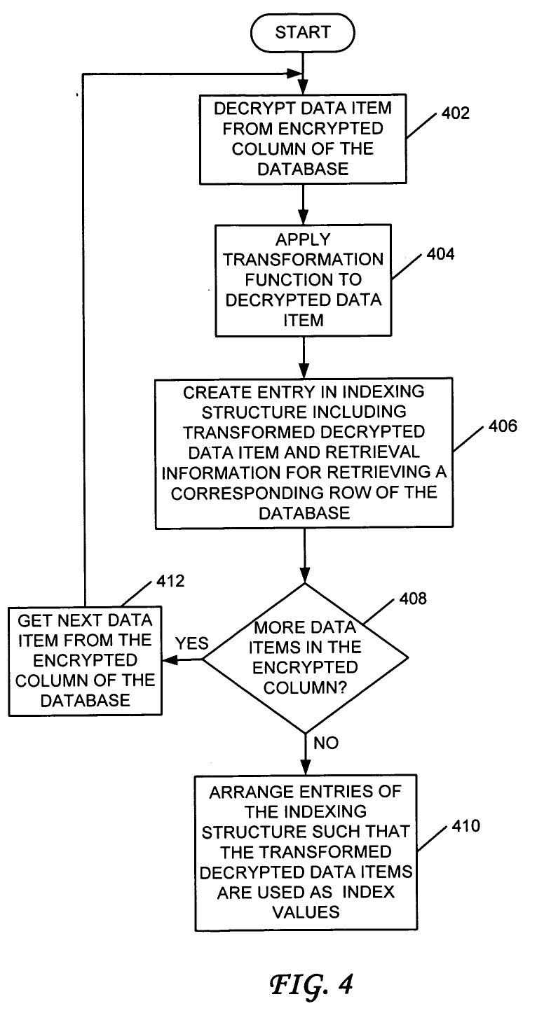

FIG. 4 is a flowchart that illustrates an exemplary process for creating an indexing structure for performing a ranged lookup of data in an encrypted column of a database. The exemplary process assumes that a transformation function was previously defined for data in the encrypted column of the database.

The process may begin by processing device 102 decrypting a data item from an encrypted column of the database (act 402). Processing device 102 may then apply the transformation function to the decrypted data item to produce a transformed data item that reveals less information than the decrypted data item (act 404). Processing device 102 may create an entry in an indexing structure, which includes the transformed decrypted data item and retrieval information such as, for example, a pointer or a link, for retrieving a corresponding row in the database (act 406). Processing device 102 may then determine whether there are more data items in the encrypted column of the database (act 408). If processing device 102 determines that more data items exist in the encrypted column of the database, then processing device 102 may access a next data item from the encrypted column of the database (act 412) and may repeat acts 402-408.

If, while performing act 408, processing device 102 determines that there are no additional data items in the encrypted column of the database, then processing device 102 may arrange the entries of the indexing structure such that the transformed decrypted data items in each entry of the indexing structure may be used as index values for performing a ranged lookup operation (act 410). In one embodiment, arranging the entries of the indexing structure may include setting the links or pointers of the indexing structure to point to other appropriate entries of the indexing structure.

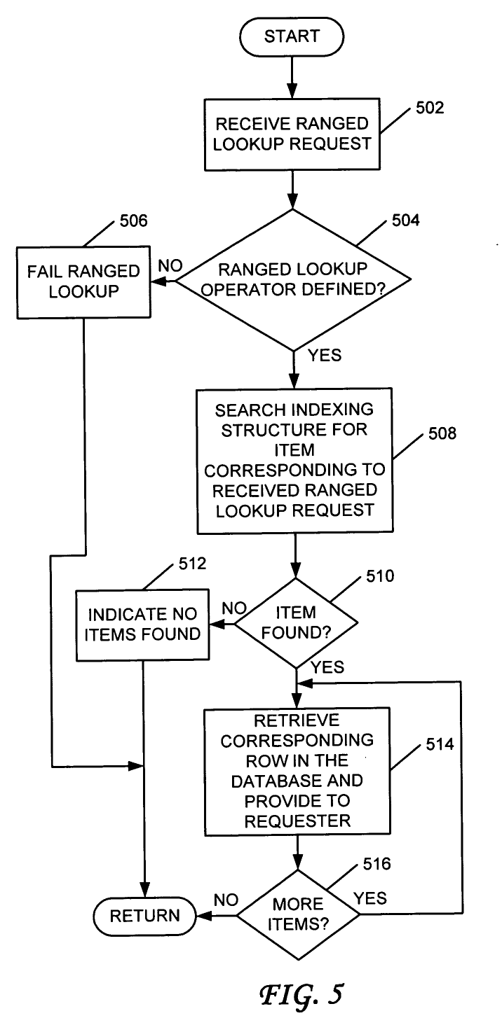

FIG. 5 is a flowchart that illustrates an exemplary process for performing a ranged lookup in an embodiment consistent with the subject matter of this disclosure. The process may begin with processing device 102 receiving a ranged lookup request, with respect to an encrypted column of a database, from a requester (act 502). The requester may be a local or a remote user or application. If the requester is remote, the requester may initiate the ranged lookup request from a remote processing device such as, for example, processing device 104, which may communicate with processing device 102 via a network such as, for example, network 106. The ranged lookup request may include a name of a field of an encrypted column of the database, a ranged lookup operator, and a value. For example, using the employee salary example from above, the user may make a ranged lookup request such as “SELECT * FROM table_{—}1 WHERE salary <10000”. The database system may intemally translate the ranged lookup request to “SELECT * FROM table_{—}1 WHERE salary.ranged_lookup <f(10000), where table_{—}1 is a table of the database system, salary.ranged_lookup indicates a ranged lookup on a salary column of table_{—}1, and f(10000) corresponds to a value produced by applying a transformation function to the value, 10000. Thus, operations of the ranged lookup may be performed transparently with respect to a requester.

After receiving the ranged lookup request, processing device 102 may determine whether a ranged lookup operator of the ranged lookup request is defined for use on the encrypted column of the database (act 504). In one implementation, ranged lookup operators such as, for example, “<”, “≦”, “>” “≧” and “LIKE”, as well as other, or different ranged lookup operators may be defined for performing a ranged lookup operation on the encrypted column of the database. “<” may be used to find entries in the database having a value less than a particular value, “≦” may be used to find entries in a database having a value less than or equal to a particular value, “>” may be used to find entries in the database having a value greater than a particular value, “≧” may be used to find entries in the database having a value greater than or equal to a particular value, and “LIKE” may be used to find matching entries that may have been truncated by application of a transformation function such as, for example, entries that match a particular value for a last four digits of a Social Security number.

If, during act 504, processing device 102 determines that the ranged lookup operator in the ranged lookup request is not defined with respect to the encrypted column, then processing device 102 may return an indication to the requester that the ranged lookup request could not be performed (act 506).

If, during act 504, processing device 102 determines that the ranged lookup operator in the ranged lookup request is defined with respect to the encrypted column, then processing device 102 may search or traverse an indexing structure such as, for example, the indexing structure of FIGS. 3A and 3B, or another type of indexing structure for an item corresponding to the received ranged request lookup (act 508). Processing device 102 may then determine whether a corresponding item was found as a result of performing act 508 (act 510). If processing device 102 determines that a corresponding item was not found, then processing device 102 may return an indication to the requester indicating that no corresponding item was found (act 512).

If processing device 102 determines that a corresponding item was found, as a result of performing act 508, then processing device 102 may use retrieval information included in an entry of the indexing structure corresponding to the found item to retrieve a corresponding row in the database and to provide the corresponding row to the requester (act 514). Processing device 102 may then use the indexing structure to determine whether additional items satisfy the ranged lookup request (act 516). In one implementation, act 516 may be performed by processing device 102 accessing a link to entries of the indexing structure having an index value equal to the index value of the current entry of the indexing structure, and by traversing the indexing structure, in a manner as illustrated by the exemplary indexing structure of FIG. 3B. If processing device 102 determines that one or more items exist, which satisfy the ranged lookup request, then acts 514-516 may be repeated.

The process may end when processing device 102 determines that no additional items satisfy the ranged lookup request.

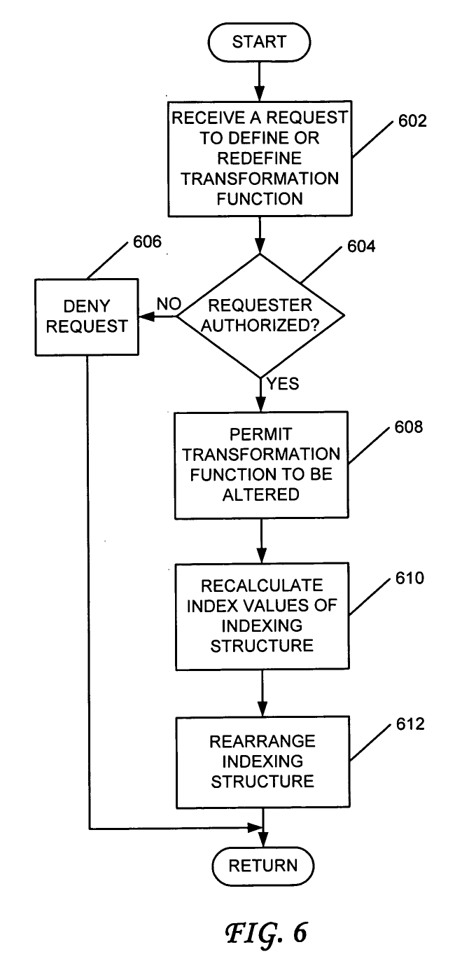

FIG. 6 is a flowchart of an exemplary process that may be implemented in embodiments consistent with the subject matter of this disclosure. The flowchart of FIG. 6 illustrates an exemplary process that may be performed when a user defines or redefines a transformation function for an encrypted column of the database. The process may begin with processing device 102 receiving a request from a requester such as, for example a local or remote user, to define or redefine a transformation function for items in an encrypted column of the database (act 602). For example, if the request is received from a remote requester, the request may be initiated via processing device 104 and communicated to processing device 102 via network 106. Processing device 102 may then determine whether the requester is authorized to define a transformation function (act 604). For example, in one implementation, only requesters who are authorized to access data from all encrypted columns of the database are authorized to define or redefine a transformation function for an encrypted column of the database. If processing device 104 determines that the requester is not authorized to define or redefine the transformation function for an encrypted column of the database, then processing device 104 may deny the request to define or redefine the transformation function (act 606).

If processing device 104 determines that the requester is authorized to define or redefine a transformation function, then processing device 104 may permit the transformation function to be defined or altered by a requester (act 608). Processing device 104 may then recalculate the index values of the indexing structure (act 610). For example, processing device 104 may access data items from the encrypted column, decrypted data items, and apply a transformation function to produce a transformed data item. The transformed data item may then be stored as an index value in an entry of the indexing structure. Processing device 104 may repeat the recalculating of the index values of the indexing structure until all index values have been recalculated. After all of the index values of the indexing structure have been recalculated, processing device 104 may rearrange the indexing structure (act 612). For example, in an indexing structure such as the indexing structure shown in FIGS. 3A and 3B, links or pointers to entries having an index value less than a particular value, greater than a particular value, or equal to a particular value may be updated according to the recalculated index values of the indexing structure.

### CONCLUSION

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above description may contain specific details, they should not be construed as limiting the claims in any way. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

We claim as our invention:

1. A method for performing a ranged lookup on an encrypted column in a database, the method comprising:
accessing, based on a received ranged lookup request with respect to the encrypted column in the database, at least one entry of a plurality of entries of an indexing structure of the database, each of the plurality of entries of the indexing structure including a respective data item and retrieval information for retrieving a corresponding row in the database, the respective data item having been decrypted from the encrypted column in the database and transformed by a transformation function; and
retrieving a row of the database by using the respective retrieval information of one of the plurality of entries of the indexing structure when the respective data item of the one of the plurality of the entries of the indexing structure satisfies the received ranged lookup request, wherein:
the plurality of entries of the indexing structure are arranged according to the respective data items, such that the respective data items are index values of the indexing structure, and
operations of the ranged lookup request are performed transparently with respect to a requester of the ranged lookup request.

2. The method of claim 1, wherein the indexing structure includes a B-tree.

3. The method of claim 1, wherein the transformation function transforms a decrypted data item from the encrypted column so as to reveal less information from the decrypted data item.

4. The method of claim 1, wherein the transformation function transforms a decrypted data item from the encrypted column to a value representing one of a plurality of categories.

5. The method of claim 1, further comprising:
defining at least one ranged lookup operator permitted to be used in the ranged lookup on the encrypted column in the database.

6. The method of claim 1, further comprising:
permitting a user to define a transformation function for transforming respective decrypted data items from the encrypted column to produce the respective data items of the plurality of entries of the indexing structure such the respective data items of the plurality of entries of the indexing structure reveal less information than the respective decrypted data items.

7. The method of claim 1, further comprising:
permitting a user to define a transformation function for transforming respective decrypted data items from the encrypted column to produce the respective data items of the plurality of entries of the indexing structure such the respective data items reveal less information than the decrypted data items; and
recalculating, when the user defines a new transformation function, at least one of the respective data items of the plurality of entries of the indexing structure.

8. The method of claim 1, further comprising:
permitting only users, who have authority to retrieve and modify plaintext data from all encrypted columns of the database, to define the transformation function for transforming respective decrypted data items from the encrypted column to produce the respective data items of the plurality of entries of the indexing structure such the respective data items reveal less information than the decrypted data items.

9. A machine-readable medium having instructions stored therein for at least one processor, the machine-readable medium comprising:
instructions for decrypting an encrypted data item of an encrypted column of a database to produce a decrypted data item;
instructions for transforming the decrypted data item according to a transformation function to produce a decrypted transformed data item;
instructions for creating an indexing structure for a database, the indexing structure for use in performing a ranged lookup on the encrypted column in the database, the indexing structure including a plurality of entries, each of the plurality of entries including retrieval information for retrieving a corresponding row in the database, and a respective decrypted transformed data item corresponding to a respective encrypted data item of the encrypted column of the database, wherein
the plurality of entries of the indexing structure are arranged according to the respective decrypted transformed data items, such that the respective decrypted transformed data items are index values of the indexing structure.

10. The machine-readable medium of claim 9, further comprising:
instructions for recalculating the decrypted transformed data items of the indexing structure and rearranging the plurality of entries of the indexing structure when the transformation function is altered.

11. The machine-readable medium of claim 9, further comprising:
instructions for permitting the transformation function to be altered only by users with authority to retrieve and modify plaintext data from all encrypted columns of the database.

12. The machine-readable medium of claim 9, wherein the transformation function is arranged to transform a decrypted data item to produce a decrypted transformed data item that reveals less information than the decrypted data item.

13. The machine-readable medium of claim 9, wherein the indexing structure includes a B-tree.

14. The machine-readable medium of claim 9, further comprising instructions for defining at least one ranged lookup operator for performing a ranged lookup on the encrypted column of the database.

15. A method for providing a remote database for performing a ranged lookup on an encrypted column of the database, the method comprising:
receiving a remote request, from a requester via a network, to perform the ranged lookup for at least one database entry satisfying the remote request;
traversing an indexing structure including a plurality of entries to find at least one of the plurality of entries having an index value satisfying the remote request, each of the plurality of entries including retrieval information for retrieving a corresponding row in the database, and a respective index value corresponding to a respective decrypted data item of the encrypted column having been transformed by a transformation function;
retrieving a row of data from the database by using the respective retrieval information from the at least one of the plurality of entries having the respective index value satisfying the remote request; and
providing the row of data from the database to the requester, wherein operations of the ranged lookup are performed transparently with respect to the requester.

16. The method of claim 15, further comprising:
transparently applying the transformation function to the remote request received from the requester.

17. The method of claim 15, wherein the transformation function transforms a decrypted data item from the encrypted column such that less information from the decrypted data item is revealed.

18. The method of claim 15, further comprising:
permitting the requester to define the transformation function only when the requester has authority to retrieve and modify plaintext data from all encrypted columns of the database, wherein
the transformation function transforms a decrypted data item from the encrypted column such that less information from the decrypted data item is revealed.

19. The method of claim 15, further comprising:
permitting the requester to define the transformation function;
recalculating at least one respective index value of the indexing structure when the requester redefines the transformation function; and
rearranging the plurality of entries of the indexing structure according to the respective index values.

20. The method of claim 15, further comprising:
informing the requester of a failed ranged lookup when a ranged lookup operator included in the remote request from the requester is not defined for ranged lookup operations on the encrypted column of the database.
